(19) United States
(12) Patent Application Publication
(10) Pub. No.: US 2014/0075420 A1
(43) Pub. Date: Mar. 13, 2014

(54) GENERATING HARDWARE PROFILES BY A SOFTWARE DEVELOPMENT ENVIRONMENT

(71) Applicant: Jean Baptiste Maurice Queru, Foster City, CA (US)

(72) Inventor: Jean Baptiste Maurice Queru, Foster City, CA (US)

(73) Assignee: GOOGLE INC., Mountain View, CA (US)

(21) Appl. No.: 13/487,751

(22) Filed: Jun. 4, 2012

(51) Int. Cl. G06F 9/445

(52) U.S. Cl. 717/134; 717/124

(57) ABSTRACT

Methods, systems, and apparatus, including computer programs encoded on a computer storage medium, for generating hardware profiles by a software development environment. In one aspect, a method includes identifying a set of hardware features that are accessed by an application that is under development, generating one or more hardware profiles for one or more corresponding virtual devices based on the identified set of hardware features that are accessed by the application that is under development, invoking one or more of the virtual devices using the corresponding one or more hardware profiles, and installing the application on the one or more of the virtual devices.

### BACKGROUND

The present specification relates to the generation of hardware profiles.

Software developers often use software development kits (SDKs) to facilitate the creation of software applications for particular hardware platforms or operating systems. Software development kits may be used within integrated development environments (IDEs), and may include application programming interfaces (APIs) which allow developers to access hardware and software features through the use of a programming language. Some integrated development environments include tools such as debuggers for dynamically executing application code. Emulators can be used for modeling an actual device by defining hardware and software features for the device. To test a software application, the application can be executed on a physical or an emulated device.

### SUMMARY

According to one innovative aspect of the subject matter described in this specification, a software application that is under development using an SDK may be automatically analyzed to identify hardware features that are required for the application to execute, or hardware features that may be invoked by the application during execution, and relevant hardware profiles that include the identified hardware features are generated for use by virtual machines that test the application. In doing so, the generation of irrelevant hardware profiles, such as duplicate hardware profiles, hardware profiles with improbable combinations of hardware features, or hardware profiles that do not include the necessary hardware features for the software application to run, can be avoided, reducing the time and effort necessary to test the software application.

Another innovative aspect of the subject matter described in this specification, a process includes identifying, by a software development environment, a set of hardware features that are accessed by an application that is under development in the software development environment, generating, by the software development environment, one or more hardware profiles for one or more corresponding virtual devices based on the identified set of hardware features that are accessed by the application that is under development in the software development environment, invoking, by the software development environment, one or more of the virtual devices using the corresponding one or more hardware profiles, and installing, by the software development environment, the application on the one or more of the virtual devices.

Other embodiments of these aspects include corresponding systems, apparatus, and computer programs, configured to perform the actions of the methods, encoded on computer storage devices.

These and other embodiments may each optionally include one or more of the following features. For instance, identifying the set of hardware features includes performing a static analysis of computer code associated with the application that is under development in the software development environment; performing the static analysis includes performing a keyword search on the computer code for terms that are associated with access to hardware features; performing the static analysis includes analyzing the computer code for declarations associated with access to hardware features; performing the static analysis includes analyzing the computer code for requests to use permissions associated with access to hardware features; the static analysis is automated; identifying the set of hardware features includes performing a dynamic analysis of a binary file associated with the application that is under development in the software development environment; the dynamic analysis is automated; performing the dynamic analysis includes running the application in an emulator, and detecting function calls associated with access to hardware features. made by the application to the emulator; generating the hardware profiles includes generating one or more hardware profiles that each include a different combination of hardware features; generating the hardware profiles includes generating one or more hardware profiles that each include a different combination of hardware features, and that all include the set of hardware features that are accessed by the application that is under development in the software development environment; generating the hardware profiles includes generating one or more hardware profiles that each include a different combination of hardware features, where at least some of the hardware profiles include fewer than all of the set of hardware features that are accessed by the application that is under development in the software development environment; generating the hardware profiles includes generating one or more hardware profiles that each include a different combination of hardware features, where at least some of the hardware profiles exclude one or more hardware features from the set of hardware features that are not required by the application to run; generating the hardware profiles includes generating one or more hardware profiles that each include a different combination of hardware features, where at least some of the hardware profiles exclude two or more hardware features that are unlikely to occur together on an actual device; and/or generating the hardware profiles includes generating one or more hardware profiles that collectively include fewer than all possible combinations of hardware features.

Advantageous implementations may include one or more of the following features. Application code may be analyzed to identify required and optional features (e.g., hardware, operating system, software, etc.) used by the application. Different features may be combined to create profiles for existing devices, and for devices which do not currently exist but may eventually be created in the future. Automated test suites may be executed against multiple virtual devices, each including a possible combination of features. Knowledge of which combinations of features are likely to be encountered may be used to prioritize or restrict a set of virtual devices under consideration.

The details of one or more implementations are set forth in the accompanying drawings and the description below. Other potential features and advantages will become apparent from the description, the drawings, and the claims.

### BRIEF DESCRIPTION OF THE DRAWINGS

FIGS. 1 and 2 are diagrams of example systems that may generate hardware profiles.

FIG. 3 is a flow chart illustrating an example process for generating hardware profiles by a software development environment.

FIG. 4 shows an example user interface of a software development environment that may generate hardware profiles.

FIG. 5 shows an example of a generic computer device and a generic mobile computer device.

Like reference numbers and designations in the various drawings indicate like elements.

### DETAILED DESCRIPTION

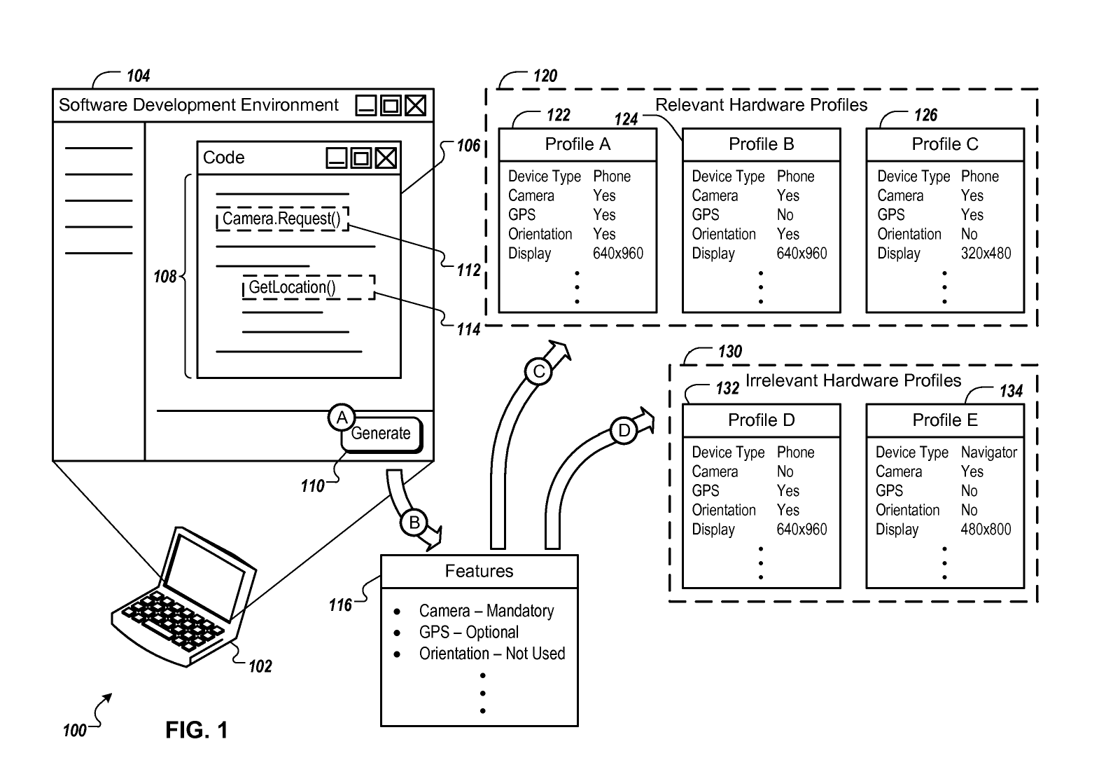

FIG. 1 is a diagram of an example system 100 that may generate hardware profiles. FIG. 1 also illustrates an example flow of data, shown in states (A) to (D). States (A) to (D) may occur in the illustrated sequence, or they may occur in a sequence that is different than in the illustrated sequence. For example, states (C) and (D) may occur concurrently.

In general, hardware profiles may be generated by the system 100 as part of a software application development process. A software developer, for example, can use a computing device 102 to access a software development environment (e.g., an integrated development environment (IDE)) to create, maintain, install, and test application source code under development. Based at least in part on static and dynamic analysis of the source code, for example, the software development environment may identify features (e.g., hardware, operating system, software, etc.) used by the application, and may automatically generate corresponding hardware profiles based on the identified features. The profiles may be used by virtual devices, for example, during application development and testing.

As the variety of possible feature combinations may be vast for existing computing devices (e.g., phones, tablets, readers, laptops, etc.) and for potential future devices, automated hardware profile discovery and generation may help developers track the various combinations and to produce software applications that may be executed by a wide range of devices. For example, potential incompatibilities between an application and existing and/or potential future devices may be identified and addressed before the application is provided to application users. Moreover, as only a subset of possible devices may be relevant for a particular application, automatic generation of relevant (and/or probable) profiles may streamline the application development and testing process.

In further detail, the system 100 includes the computing device 102 which can present an interface 104 associated with a software development environment. The computing device 102 includes one or more processors configured to execute instructions stored by a computer-readable medium for performing various device operations, such as input/output, communication, data processing, and the like. For example, the computing device 102 may include one or more client computing devices (e.g., desktop computers, laptop computers, notebook computers, smartphones, or other appropriate computing devices) and/or may include one or more servers (e.g., a backend server farm). Input received by a client computing device, for example, may be provided to a backend system (e.g., the cloud) for processing. As another example, processing may be distributed between one or more client computing devices (e.g., in a peer-to-peer configuration) and/or servers.

The software development environment interface 104 may include a code interface 106. A software developer, for example, may use the code interface 106 to access and maintain existing application code and to create new application code. In the present example, the code interface 106 can be used for the development and presentation of computer code 108. In general, computer code may include instructions written in a computer programming language for execution by a computer processor. Some developers may use a software development kit (SDK) that may include one or more application programming interfaces (APIs), libraries, and/or frameworks, for assisting in the development of computer code, and for targeting the code for execution on various operating systems and devices.

Computer code may include constructs such as statements, objects, graphical representations, and resources (e.g., support files, manifests, etc.) which can specify the behavior of a computer application. In general, the computer code for a computer application may be stored on computer-readable media (e.g., disks, flash drives, etc.) or in computer memory, using a collection of one or more files, databases, or other appropriate mechanisms. To identify features (e.g., hardware, operating system, software, etc.) accessed by a computer application under development, for example, a software development environment may perform static and/or dynamic analysis of the application source code. In general, static analysis may be performed without executing an application's code, whereas dynamic analysis may be performed by executing the application's code on a real or virtual processor. Static analysis, for example, may include techniques for analyzing source code without executing the code, such as data-flow analysis, control-flow analysis, parsing, and searching of the statements, objects, graphical representations, and resources associated with a computer application. Dynamic analysis, for example, may include techniques for analyzing programs under execution, may include appropriate code coverage techniques, and may include the use of automatically or manually generated test scripts for passing input to an application during execution.

Referring to the example data flow, during state (A), a user (e.g., a software developer) may interact with (e.g., select, click, etc.) a control 110 associated with the interface 104 to indicate that hardware profiles are to be generated for corresponding virtual devices, based on features that are accessed by an application under development. In response to the user interaction, for example, a software development environment associated with the interface 104 may perform static and/or dynamic analysis of the computer code 108 to identify one or more features used by the application. In the present example, the software development environment may identify in the computer code 108 a feature reference 112 (e.g., a reference to a specific hardware feature, such as a camera), and a feature reference 114 (e.g., a reference to general feature which may be provided through an operating system or a software library, such as a request to get a device's current location). Various aspects of a computer application may be analyzed, such as the computer code itself, and support files (e.g., manifest, permissions, etc.) associated with the application.

During state (B), a set of identified features may be compiled for the application under development. The set of features, for example, may include features provided by device hardware, operating systems, and software, such as audio playback support, audio recording support, battery support, Bluetooth support, camera support (including camera sub-features such as flash and autofocus), keyboard support, location detection services, near field communication, secure digital (SD) card support, sensors (e.g., accelerometer, barometer, compass, gyroscope, light, proximity, etc.), screen orientation (i.e., landscape and portrait), touchscreen support, USB support, WiFi support, Voice over IP (VoIP) support, and the specification of particular device characteristics, such as RAM and screen sizes. In the present example, a set of features 116 may be considered by an application development environment, based on static and/or dynamic analysis of the computer code 108.

A feature may be identified as being used or unused in regard to a particular application. Used features may further be classified as mandatory features or optional features. Mandatory features are generally required for proper application execution. In the present example, based on the feature reference 112, a camera feature may be identified as being mandatory for the application under development. For example, a software development environment associated with the interface 104 may identify the declaration, instantiation, and use of a code object within the computer code 108 for interfacing with a device's camera. As another example, the software development environment may examine the application's manifest file to determine that the application explicitly declares a camera as being required, or that the application requests permission to access the camera. Thus, in the present example, a device without a camera may be considered as unsuitable for executing the application.

In general, optional features may be used by an application if available, but are not required for application execution. In the present example, based on the feature reference 114, a GPS feature may be identified as being optional for the application under development. For example, a software development environment associated with the interface 104 may identify the use of a statement (e.g., a function call, an object method, etc.) within the computer code 108 for generically identifying a device's location. Based on a known implementation of a particular method (e.g., “GetLocation”), for example, a particular feature (e.g., GPS hardware) may be used by the method when available (e.g., to identify a device's current location), and an alternate mechanism (e.g., network-based geo location, user prompting, etc.) may be used when the feature is unavailable. As another example, conditional statements (e.g., conditional branching code for detecting the presence or absence of particular features, error handling code, etc.) may be identified within the computer code 108 for providing alternate application behavior if certain features are permanently or temporarily unavailable. Thus, in the present example, a device without GPS capabilities may be considered as potentially suitable for executing the application.

In general, unused features are not referenced by an application and are not required for the application's execution. In the present example, based on an absence of references within the computer code 108, an “orientation” feature may be identified as being not used by the application under development. For example, a particular application may not include code or explicit requirements for any particular sort of screen orientation (i.e., portrait or landscape). Thus, in the present example, device screen orientation features may not affect application performance.

During states (C) and (D), hardware profiles may be generated by the software development environment, based on the identified set of features accessed by the application under development. For example, based on the set of features 116, a set of hardware profiles 120 may be identified as being relevant (e.g., suitable for consideration during application development, debugging, testing, etc.) and a set of hardware profiles 130 may be identified as being irrelevant (e.g., unsuitable for executing the application under development and/or unlikely to exist). Hardware profiles, for example, may include the profiles of actual devices, and may include the profiles of potential devices that may eventually be created. The relevant hardware profiles 120 and the irrelevant profiles 130 are shown here for illustrative purposes. In general, the possible combinations of features may be vast, may change over the course of development of a particular application, and may change as device manufacturers develop new features and incorporate the features into new devices.

Referring to the relevant hardware profiles 120 in the present example, a profile 122 (“Profile A”) is included for a phone device which includes a camera, GPS hardware, screen orientation features, and a 640×960 pixel display. A profile 124 (“Profile B”), for example, is included for a phone device which includes a camera, screen orientation features, and a 640×960 pixel display, but does not include GPS hardware. A profile 126 (“Profile C”), for example, is included for a phone device which includes a camera, GPS hardware, and a 320×480 pixel display, but does not include support for particular screen orientation features. The hardware profiles 120 may be considered relevant, for example, as they each include mandatory hardware (e.g., the camera). The presence or absence of optional hardware features (e.g., GPS hardware) and unused features (e.g., support for a particular screen orientation) in profiles considered in the present example does not necessarily impact their potential relevance to the application under development.

Referring to the irrelevant hardware profiles 130 in the present example, a profile 132 (“Profile D”) is included for a phone device which does not include a camera, but does include GPS hardware, screen orientation features, and a 640×960 pixel display. A profile 134 (“Profile E”) is included for a handheld navigation device which includes a camera and a 480×800 pixel display, but does not include GPS hardware or support for particular screen orientation features. In general, devices may be considered irrelevant if they do not include one or more mandatory features of an application under development, or if they do not exist and are unlikely to ever be created. In the present example, the profile 132 (“Profile D”) may be considered as irrelevant as it does not include a mandatory feature (e.g., a camera). The profile 134 (“Profile E”), for example, may considered irrelevant as it may be unlikely for a handheld navigation device to exclude GPS hardware.

Upon classifying possible hardware profiles as being relevant or irrelevant, for example, a software development environment can generate the relevant hardware profiles for use in developing and testing a computer application. For example, information associated with the relevant hardware profiles 120 may be provided to a command line utility or another sort of tool, and virtual devices may be invoked for each of the profiles. The software development environment, for example, may install the computer application on each of the virtual devices, and application compatibility testing can be performed.

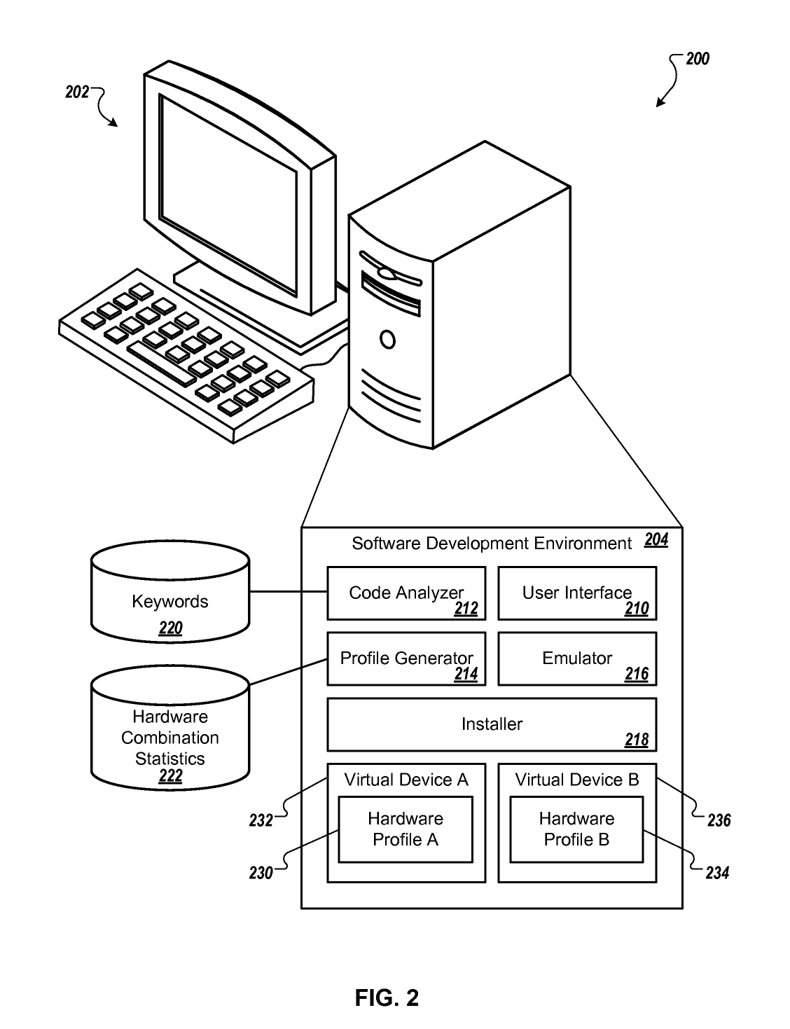

FIG. 2 is a diagram of an example system 200 that may generate hardware profiles. The system 200 in the present example includes a computing device 202, which, similar to the computing device 102 (shown in FIG. 1), may include processors configured to execute instructions stored by a computer-readable medium for performing various device operations, such as input/output, communication, data processing, etc. For example, the computing device 102 may include client computing devices (e.g., desktop computers, laptop computers, notebook computers, smartphones, or other appropriate computing devices) and/or may include servers (e.g., a backend server farm). Input received by a client computing device, for example, may be provided to a backend system (e.g., the cloud) for processing. As another example, processing may be distributed between client computing devices (e.g., in a peer-to-peer configuration) and/or servers.

The computing device 202 may be used to provide a software development environment 204. A software developer, for example, can use the software development environment 204 to create, maintain, install, and test application source code under development. Through analysis of the source code and associated support files (e.g., manifest, permissions, etc.), for example, the software development environment 204 can identify features used by the application, and can automatically generate corresponding hardware profiles based on the identified features. The profiles may be used by virtual devices, for example, during application development and testing.

The software development environment 204 may be associated with a variety of software components (e.g., programs, objects, libraries, services, etc.), including a user interface 210, a code analyzer 212, a profile generator 214, an emulator 216, and an installer 218. Two or more of the components 210, 212, 214, 216, and 218 may be implemented on the same device, or on different devices, such as devices included in a backend system or peer-to-peer network. The computing device 202 and the software development environment 204 may also communicate with one or more data storage systems, including a keywords data store 220 and a hardware combination statistics data store 222. The data stores 220 and 222 can implement databases, data services, file systems, and the like to add, remove, and maintain data used by the system 200.

Similar to the interface 104 (shown in FIG. 1), for example, the user interface 210 may be used (e.g., by a software developer) to access and maintain an existing application, to create new application code, and to generate and track profiles for corresponding virtual devices. The code analyzer 212, for example, may be used to identify features that are accessed by an application that is under development. In some implementations, the code analyzer 212 may access the keywords data store 220 when identifying features. For example, a keyword search may be performed on computer code under development to identify terms that are associated with certain features.

When hardware, operating system, and software features have been identified, for example, the profile generator 214 may be used to generate hardware profiles for corresponding virtual devices, based at least in part on the identified set of features accessed by the application under development. Hardware profiles, for example, may include the profiles of actual and/or potential devices, and may be implemented as files or other suitable data structures. Virtual devices, for example, may be used to emulate the behavior of actual and/or potential physical devices, and may be hosted and executed by the software development environment 204. In the present example, a hardware profile 230 (“Hardware Profile A”) may be generated for a corresponding virtual device 232 (“Virtual Device A”), and a hardware profile 234 (“Hardware Profile B”) may be generated for a corresponding virtual device 236 (“Virtual Device B”). In some implementations, the profile generator 214 may interface with the hardware combination statistics data store 222 when generating hardware profiles. For example, based on knowledge of common hardware configurations, appropriate correlation analysis techniques may be used to identify likely and unlikely feature combinations. Profiles associated with likely feature combinations may be generated, for example, whereas profiles associated with unlikely feature combinations may be filtered or removed from consideration.

To test an application under development for compatibility with an actual or potential device, for example, an appropriate virtual device may be invoked, and the application may be installed on the virtual device. For example, to test an application for compatibility with an actual or potential device including the features of the hardware profile 230 (“Hardware Profile A”), the software development environment 204 can use the emulator 216 to invoke the virtual device 232 (“Virtual Device A”) using “Hardware Profile A”, and can use the installer 218 to install the application on “Virtual Device A”. In some implementations, an application may be concurrently installed and executed on multiple virtual devices, each device associated with a different hardware profile. For example, the software development environment 204 may implement an automated test script, and may concurrently test both “Virtual Device A” and “Virtual Device B” for compatibility with the application under development.

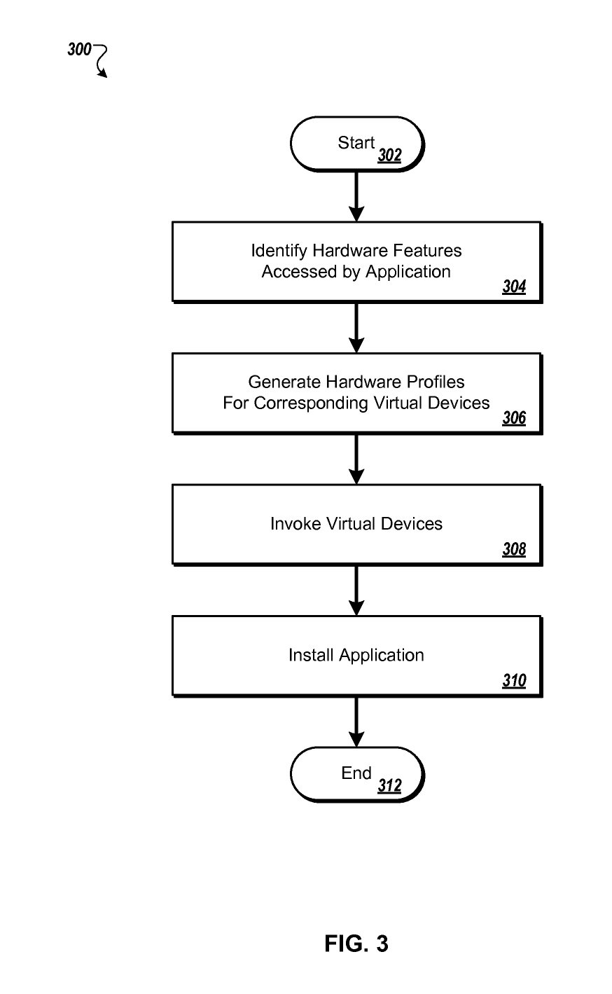

FIG. 3 is a flow chart illustrating an example process 300 for generating hardware profiles by a software development environment. In some implementations, the process 300 may be performed by the systems 100 and/or 200, and will be described as such for clarity. Briefly, the process 300 includes identifying hardware features accessed by an application, generating hardware profiles for corresponding virtual devices, invoking the virtual devices, and installing the application.

In more detail, when the process 300 begins (302), hardware features accessed by an application that is under development in a software development environment are identified (304) by the software development environment. For example, the software development environment 204 (shown in FIG. 2) may be used by a software developer to develop a micro-blogging application to be targeted to mobile devices (e.g., phones, tablets, etc.). The micro-blogging application in the present example may access various hardware features. Some of the hardware features, for example, may be mandatory. For example, the micro-blogging application may require an Internet connection, as posting entries using the Internet connection may be considered as a core capability of the application. Some of the hardware features, for example, may be optional. In general, an optional hardware feature may be used by an application when available, but the application may continue to operate if the feature is unavailable. For example, a microphone may be an optional feature for the micro-blogging application, as the ability to receive voice input may be included by the micro-blogging application if a microphone is available, yet the application may also function without a microphone. In the present example, the micro-blogging application may include code to check for the presence of a microphone, and if the microphone does not exist, to remove a capability (e.g., voice input) from selection by a user, to provide the user with an alternative capability (e.g., suggest another form of input), or to provide some other sort of handling behavior. Some of the hardware features, for example, may be unused. For example, the micro-blogging application may contain no code references directed to a device's accelerometer feature. Thus, whether an accelerometer is included on a particular device may be immaterial to the micro-blogging application of the present example.

In some implementations, identifying hardware features may include performing a static analysis of computer code associated with the application that is under development in the software development environment. For example, the software development environment 204 can use the code analyzer 212 (shown in FIG. 2) to perform static analysis of computer code. Static analysis, for example, may include techniques such as data-flow analysis, control-flow analysis, parsing, and searching of the statements, objects, graphical representations, and resources associated with a computer application's code. In general, static analysis may be performed without executing the code, and may be automated in some implementations. For example, the code analyzer 212 may include automated routines for traversing an application's source code and associated files, which may be performed as a background process during application development (e.g., as features references are added and removed), and/or upon user command.

In some implementations, performing static analysis may include performing a keyword search on computer code for terms that are associated with access to hardware features. For example, the code analyzer 212 can access the keywords data store 220 (shown in FIG. 2) to identify potentially relevant terms. In the present example, based on static analysis of the micro-blogging application, references (e.g., object references, function calls, methods, procedures, declarations, permissions requests, etc.) can be identified within the application's source code and associated files, and the references may be checked for matching terms included in the keywords data store 220. If, for example, the micro-blogging application includes a reference to a code object for managing Internet connections, and/or includes function call to open a connection to the Internet, an Internet connectivity feature may be identified as being mandatory or optional for the application.

In some implementations, techniques for classifying a hardware feature as being mandatory or optional may include control flow and/or data flow analysis. Based on an application's control flow graph, for example, the code analyzer 212 may determine that access to a particular hardware feature is always requested and used by the application. In the present example, the micro-blogging application may request a connection to the Internet on startup or some other computer program point that is on a direct program path. When requesting the Internet connection, for example, the micro-blogging application may continue if the feature is available and may explicitly terminate execution if the feature is unavailable. Thus, in the present example, the code analyzer 212 may identify Internet connectivity as a mandatory hardware feature for the micro-blogging application. As another example, based on an application's control flow graph, the code analyzer 212 may determine that a particular hardware feature is sometimes or optionally requested by the application. In the present example, the micro-blogging application may include conditional branching code that checks for the presence of a hardware feature (e.g., a microphone), using the feature if available, and continuing execution (perhaps accessing an alternate input feature, such as a keyboard feature) if the (microphone) feature is unavailable. Thus, the present example, the code analyzer 212 may identify a microphone as an optional hardware feature for the micro-blogging application.

In some implementations, performing static analysis may include analyzing computer code for declarations associated with access to hardware features. For example, the code analyzer 212 may access a feature declaration resource (e.g., a manifest file) to identify one or more hardware features used by an application. In the present example, the micro-blogging application may be associated with a manifest file that includes explicit references to an Internet feature and a microphone feature. Feature declarations, for example, may include descriptors (e.g., names), and may include indications of whether a feature is mandatory or optional. For example, a software developer may provide an entry in a manifest file declaring a feature (e.g., the Internet feature) as mandatory if an application under development is designed not to function or cannot function without a specified feature. However, if an application may use a specified feature if present, but is designed to operate without the specified feature if the feature is absent, the developer may provide an entry in the manifest file declaring the feature (e.g., the microphone feature) as optional.

In some implementations, performing static analysis may include analyzing computer code for requests to use permissions associated with access to hardware features. For example, the code analyzer 212 may access a feature permissions resource (e.g., a manifest file or permissions file) to identify one or more hardware feature permissions requested by an application. In general, permissions requests may be provided by a software developer to request application access to potentially sensitive device features from a device user. Upon installation of the application, for example, a device's operating system may present the permissions requests to the device user, and the user may elect to approve or disapprove the requests. In the present example, the micro-blogging application may be associated with permission requests for a device's Internet and microphone features.

In some implementations, identifying hardware features may include performing a dynamic analysis of a binary file associated with the application that is under development in the software development environment. In general, dynamic analysis may be performed on applications while under execution. For example, computer application source code may be compiled to a binary file, and the file may be provided to real or virtual processor. To perform dynamic analysis, for example, an application may be run in an emulator, the application may make function calls associated with access to hardware features, and the function calls may be detected and processed by the emulator. In the present example, the software development environment 204 may compile the micro-blogging application, and may execute the application using the emulator 216 (shown in FIG. 2). As the micro-blogging application runs in the emulator 216, for example, information associated with the application's execution and function calls may be provided to the software development environment 204 for analysis. If a request to access a particular feature (e.g., an Internet feature, a microphone feature, etc.) is detected, for example, the feature may be classified as mandatory or optional, depending on the nature and handling of the request. For example, if the micro-blogging application terminates or fails upon requesting a missing or otherwise unavailable feature, the feature may be classified as mandatory, whereas if the application continues appropriately upon making the request, the feature may be classified as optional.

In some implementations, the dynamic analysis may be automated. For example, the software development environment 204 may use automatic test scripts to provide input to one or more application instances executed by one or more emulators, in series or in parallel. Upon running the test scripts, for example, the software development environment 204 may maintain detailed and summary test results, which may be provided to a user for further analysis.

Profiles are generated (306) for corresponding virtual devices. In general, a set of hardware profiles may be generated that each include a different combination of hardware features. Hardware profiles, for example, may be generated by the profile generator 214 (shown in FIG. 2) included in the software development environment 204. For example, specifications for desired hardware profiles (e.g., a list of mandatory and optional features) may be provided using a command line utility or another sort of tool, and the profile generator 214 may generate the profiles, based at least in part on the provided information. The hardware profiles may be formatted as files or other appropriate types of data structures, for example. As the number of possible feature combinations may be vast, for example, automated techniques may be used for identifying and generating the different possible combinations.

In some implementations, the generated hardware profiles may all include the set of hardware features that are accessed by the application that is under development in the software development environment. Considering the micro-blogging application discussed in the present example, an Internet connection feature, a microphone feature, and a keyboard feature may all be accessed by the application. Thus, in the present example, the profile generator 214 may generate a set of profiles, each including the set of accessed features (e.g., Internet connection, microphone, keyboard), and each possibly including one or more unused features (e.g., Bluetooth, camera, GPS, etc.) and various other device characteristics (e.g., different screen sizes, RAM sizes, etc.). Although the unused features and other device characteristics may not be directly referenced by a computer application's code, the features and characteristics may potentially affect the application's performance. Thus, profiles including such unused features and device characteristics may be used for testing the application.

In some implementations, at least some of the generated hardware profiles may include fewer than all of the set of hardware features that are accessed by the application that is under development in the software development environment. Considering the micro-blogging application discussed in the present example, the Internet connection feature may be classified as a mandatory feature, and both the microphone feature and the keyboard feature may be classified as optional features. As a possibility, at least some hardware profiles may be generated which exclude one or more hardware features that are not required by the application to run. The profile generator 214, for example may generate a profile that includes the Internet connection feature, but excludes the microphone feature and the keyboard feature (i.e., optional features), and excludes one or more additional unused features. As another example, the profile generator 214 may generate a profile that includes the Internet connection feature and the microphone feature, and excludes the keyboard feature. As another example, the profile generator 214 may generate a profile that includes the Internet connection feature and the keyboard feature, but excludes the microphone feature. In general, profiles may be generated that include mandatory features, but as a possibility, at least some profiles may be generated which exclude one or more features that are required by an application under development. For example, the profile generator 214 may generate a profile that excludes the Internet connection feature for testing purposes.

In some implementations, at least some of the generated hardware profiles may exclude two or more hardware features that are unlikely to occur together on the same device. For example, the profile generator 214 may access the hardware combination statistics data store 222 to identify likely and unlikely hardware feature combinations. The hardware combination statistics data store 222, for example, may include statistics related to existing hardware configurations, and such statistics may be used to identify correlations between the presence and absence of various features or feature combinations. For example, if “Feature A” is present, “Feature B” may also be likely to be present, but “Feature C” may be likely to be absent. As another example, if “Feature D” is absent, “Feature E” may also be likely be absent, but “Feature F” may be likely to be present. As another example, certain types of devices (e.g., phones, tablets, readers, laptops, navigators, etc.) may be likely or unlikely to include certain features. To identify correlations, association rule learning or other appropriate data mining techniques may be used. By considering likely and unlikely hardware feature combinations, for example, hardware profiles may be created for modeling devices which may not currently exist, but have a reasonable possibility of eventually being created. Moreover, by generating hardware profiles that collectively include fewer than all possible combinations of hardware features, application development effort and test case creation may be focused appropriately.

The virtual devices are optionally invoked (308) by a software development environment using one or more corresponding hardware profiles. For example, the software development environment 204 may invoke one or more virtual devices (e.g., the virtual devices 232, 236, shown in FIG. 2) using one or more corresponding hardware profiles (e.g., the hardware profiles 230, 234, shown in FIG. 2), and using an emulator (e.g., the emulator 216, shown in FIG. 2). The invoked virtual devices 232, 236, for example, may be used to model existing and potential devices for application and compatibility testing purposes.

The application is optionally installed (310) on or more of the virtual devices by the software development environment, thereby ending the process (312). In the present example, the micro-blogging application may be installed on each of the virtual devices 232, 236 by the software development environment 204 using the installer 218. Using interfaces provided by each of the virtual devices 232, 236, for example, application developers, test engineers, and test scripts may provide input to instances of an application (e.g., the micro-blogging application) under test.

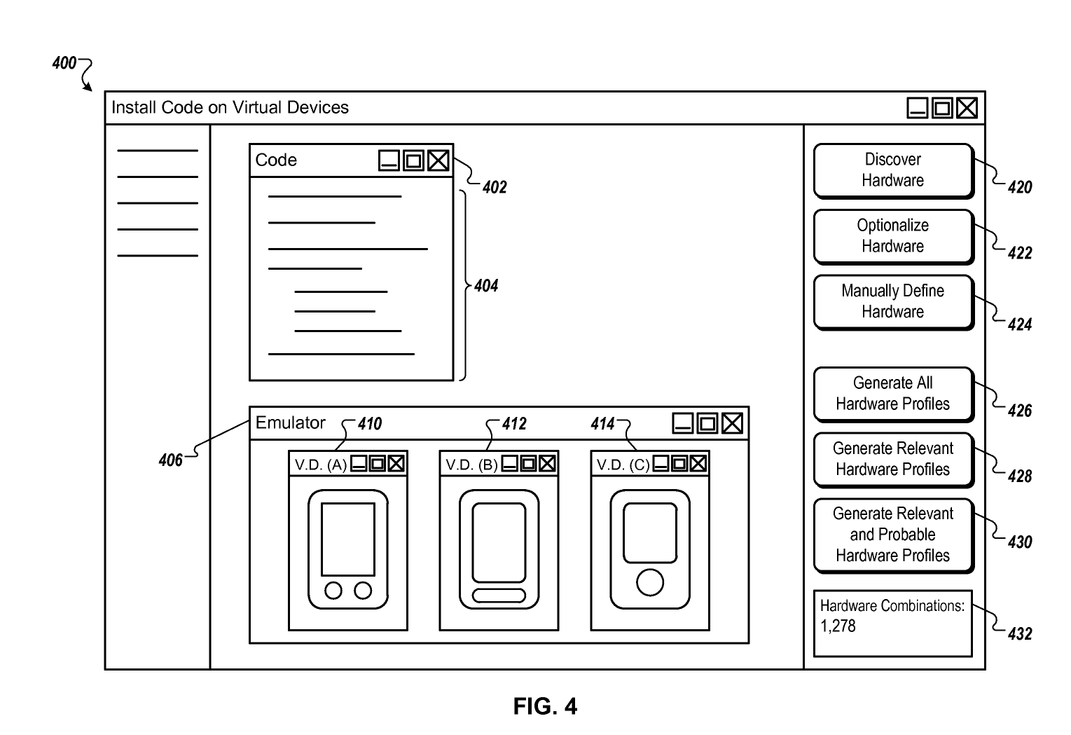

FIG. 4 shows an example user interface 400 of a software development environment that may generate hardware profiles. For example, the user interface 400 may be presented by a computing device such as the computing device 202 (shown in FIG. 2) or another appropriate device. Similar to the interface 104 (shown in FIG. 1) and the interface 210 (shown in FIG. 2), the user interface 400 may be provided by a software development environment, and may be used to access and maintain an existing application, to create new application code, to generate and track profiles for corresponding virtual devices, and to install application code on the virtual devices.

The user interface 400 can include a code interface 402. A software developer, for example, may use the code interface 402 to access and maintain existing application code and to create new application code. In the present example, the code interface 402 can be used for the development and presentation of computer code 404. The computer code 404, for example, may include statements, objects, graphical representations, and resources (e.g., support files, manifests, etc.) which can specify the actions of a computer application under development.

The user interface 400 can include an emulator interface 406. The emulator interface 406, for example, may include one or more interfaces associated with various emulated virtual devices. In the present example, the emulator interface 406 may include an interface 410 for presenting an emulated interface of “Virtual Device A”, an interface 412 for presenting an emulated interface of “Virtual Device B”, and an interface 414 for presenting an emulated interface of “Virtual Device C”. A software developer or test engineer, for example, may interact with one or more of the interfaces 410, 412, 414 when developing or testing a computer application. In some implementations, the interfaces 410, 412, 414 may be used to receive input from automated test scripts and/or to conduct dynamic analysis of computer code.

The user interface 400 may include various controls for identifying and specifying features for an application under development, and for generating profiles to be used by virtual devices during application development and testing. In the present example, a control 420 is included for discovering hardware features. Upon receiving an indication of user interaction (e.g., a button click) with the control 420, for example, a software development environment may perform static and/or dynamic analysis of the computer code 404 and associated code resources (e.g., a manifest file, a permissions file, etc.) to identify features (e.g., hardware, operating system, software, etc.) accessed by the application under development. The software development environment, for example, may identify and provide a set of features (e.g., the set of features 116, shown in FIG. 1) for user review and possible editing.

A control 422 is included in the present example for optionalizing hardware features. For example, upon discovering features accessed by an application under development, a user may elect to review and edit the set of features. Based on static and/or dynamic analysis of the computer code 404 and associated code resources, for example, the software development environment may identify some features as being mandatory, some features as being optional, and other features as being unused. By interacting with the control 422, for example, the user may request an interface for reviewing the set of identified features and for possibly reclassifying (and/or changing the implementation of) one or more of the features. For example, the software development environment may have classified a hardware feature as being mandatory, but the user may want to reclassify the feature as being optional. As another example, the user may want to specify certain device characteristics, such as a particular screen size or amount of RAM.

A control 424 is included in the present example for manually defining hardware features and/or profiles. For example, a user may interact with the control 424 to request an interface for specifying a set of features that may be accessed by an existing or by a potential (i.e., yet to be created) application, and for indicating whether such features are mandatory or optional. The set of features, for example, may be used by the software development environment for generating hardware profiles. As another example, the user may manually specify a hardware profile of an existing or potential device to be used by a virtual device for application development and testing.

A control 426 is included in the present example for generating hardware profiles. For example, a user may interact with the control 426 to generate profiles for all existing and/or all potential devices. To generate profiles for existing devices, for example, the software development environment may refer to stored information (e.g., specifications) associated with the devices. To generate profiles for potential devices, for example, the software development environment may automatically identify various combinations and permutations of available device features.

A control 428 is included in the present example for generating relevant hardware profiles. Based on a set of discovered and/or user-specified features accessed by an application under development, for example, the software development environment may generate a set of hardware profiles that are relevant to the set of features. For example, each of the relevant hardware profiles may include mandatory features accessed by the application under development, and each may or may not include one or more optional application features and unused features. Upon generating the hardware profiles, for example, each of the profiles may be used by the application development environment to invoke a virtual device instance (e.g., the virtual devices 410, 412, 414). Upon invoking the virtual devices instances, for example, the application under development may be installed, executed, and tested.

A control 430 is included in the present example for generating relevant and probable hardware profiles. Based on hardware combination statistics, for example, likely and unlikely feature combinations may be identified, and hardware profiles may be generated, based on likely feature combinations. Thus, software developers and test engineers may focus their efforts on targeting applications for existing devices, and devices that may eventually be created.

A control 432 is included in the present example for providing information about generated hardware profiles. For example, after interacting with one or more of the controls 426, 428, or 430, the user may be presented with information about hardware profiles that have been or are about to be generated. Such information may include device counts, breakdowns by category (e.g., device type, feature, etc.), and other suitable information. Moreover, as an application under development is executed by one or more of the virtual devices 410, 412, 414, information about test results may be collected by the software development environment and provided to the user. For example, virtual devices having passed or failed a particular test may be identified, assisting software developers and test engineers in identifying particular feature combinations which may suitable or unsuitable for the application under development. Using such reporting information, for example, developers may modify the application's source code to potentially increase the number of devices models which can run the application.

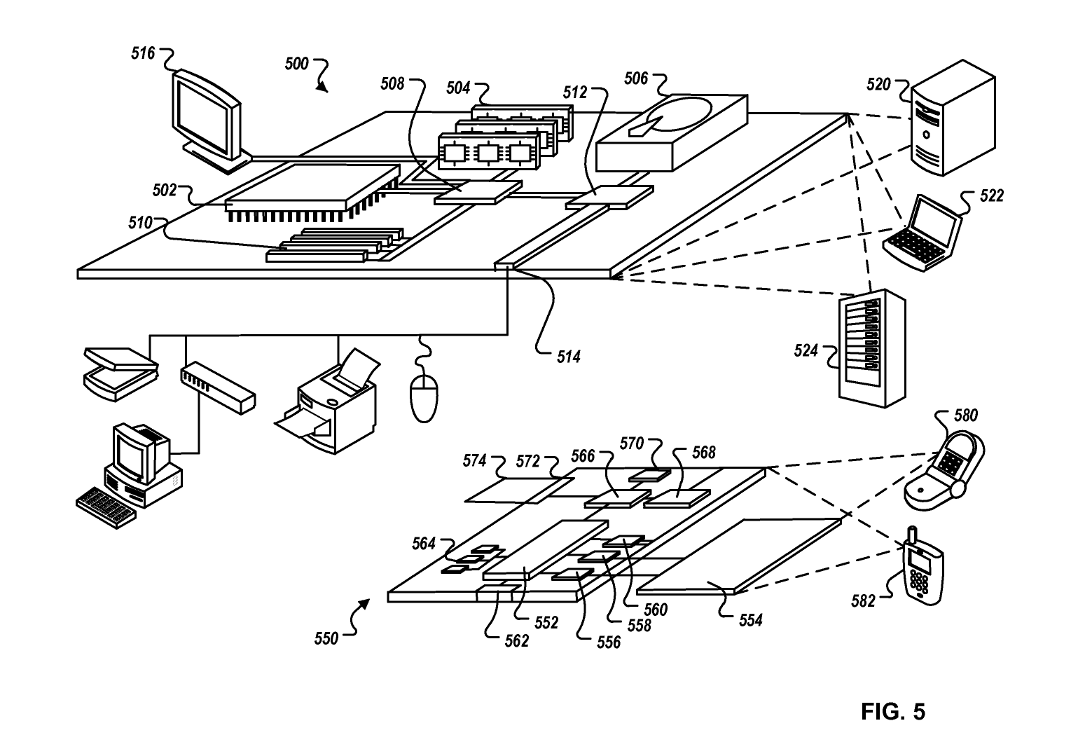

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 may process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 may execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 may be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
receiving an indication that a user has selected a control associated with obtaining virtual device profiles that are relevant to a software application that is under development in a software development environment;
in response to receiving the indication, automatically analyzing the software application that is under development in the software development environment to classify each feature of a set of hardware and software features as (i) a used feature that is used by the software application, or (ii) an unused feature that is not used by the software application and, for each feature that is classified as a used feature, to classify the used feature as (a) a mandatory used feature, or (b) an optional used feature;
selecting from among a set of virtual device profiles, a first subset of the virtual device profiles that each include, at a minimum, all of the hardware and software features that are classified as mandatory used features;
accessing data that identifies combinations of hardware and software features that are unlikely to occur together on a single device;
selecting, from among the first subset of the virtual device profiles, a second subset of the virtual device profiles that do not include one or more of the combinations of hardware and software features that are unlikely to occur together on a single device; and
outputting one or more of the virtual device profiles of the second subset as a virtual device profile that is relevant to the software application.

2-20. (canceled)

21. The method of claim 1, comprising:
invoking, by the software development environment, one or more of the virtual devices using the corresponding one or more virtual device profiles; and
installing, by the software development environment, the application on the one or more of the virtual devices.

22. The method of claim 1, wherein selecting the first subset of the virtual device profiles comprises selecting, from among the set of virtual device profiles, one or more excluded virtual device profiles that each do not include, at a minimum, all of the hardware and software features that are classified as mandatory used features, and excluding the excluded virtual device profiles from the first subset.

23. The method of claim 1, wherein one or more of the virtual device profiles of the first subset, but fewer than all of the virtual device profiles of the first subset, include hardware and software features that are classified as optional used features.

24. The method of claim 1, wherein automatically analyzing the software application comprises performing a static analysis of computer code associated with the software application that is under development in the software development environment.

25. The method of claim 24, wherein performing the static analysis comprises determining, for each feature of the set of hardware and software features, whether the computer code includes one or more particular keywords that are associated with accessing the feature.

26. The method of claim 24, wherein performing the static analysis comprises determining, for each feature of the set of hardware and software features, whether the computer code includes one or more particular declarations that are associated with accessing the feature.

27. The method of claim 24, wherein performing the static analysis comprises determining, for each feature of the set of hardware and software features, whether the computer code includes one or more request-to-use permissions associated with accessing the feature.

28. The method of claim 1, wherein automatically analyzing the software application comprises performing a dynamic analysis of a binary file corresponding to the software application that is under development in the software development environment to identify, for each feature of the set of hardware and software features, one or more particular function calls that are associated with accessing the feature.

29. The method of claim 28, wherein performing the dynamic analysis comprises:
running the software application in an emulator, and
detecting the one or more particular function calls that are associated with access to the hardware and software features made by the software application to the emulator.

30. The method of claim 1, wherein each virtual device profile of the second subset includes a different combination of hardware and software features.

31. A system comprising:
one or more computers and one or more storage devices storing instructions that are operable, when executed by the one or more computers, to cause the one or more computers to perform operations comprising:
receiving an indication that a user has selected a control associated with obtaining virtual device profiles that are relevant to a software application that is under development in a software development environment;
in response to receiving the indication, automatically analyzing the software application that is under development in the software development environment to classify each feature of a set of hardware and software features as (i) a used feature that is used by the software application, or (ii) an unused feature that is not used by the software application and, for each feature that is classified as a used feature, to classify the used feature as (a) a mandatory used feature, or (b) an optional used feature;
selecting from among a set of virtual device profiles, a first subset of the virtual device profiles that each include, at a minimum, all of the hardware and software features that are classified as mandatory used features;
accessing data that identifies combinations of hardware and software features that are unlikely to occur together on a single device;
selecting, from among the first subset of the virtual device profiles, a second subset of the virtual device profiles that do not include one or more of the combinations of hardware and software features that are unlikely to occur together on a single device; and
outputting one or more of the virtual device profiles of the second subset as a virtual device profile that is relevant to the software application.

32. The system of claim 31, comprising:
invoking, by the software development environment, one or more of the virtual devices using the corresponding one or more virtual device profiles; and
installing, by the software development environment, the application on the one or more of the virtual devices.

33. The system of claim 31, wherein selecting the first subset of the virtual device profiles comprises selecting, from among the set of virtual device profiles, one or more excluded virtual device profiles that each do not include, at a minimum, all of the hardware and software features that are classified as mandatory used features, and excluding the excluded virtual device profiles from the first subset.

34. The system of claim 31, wherein one or more of the virtual device profiles of the first subset, but fewer than all of the virtual device profiles of the first subset, include hardware and software features that are classified as optional used features.

35. The system of claim 31, wherein automatically analyzing the software application comprises performing a static analysis of computer code associated with the software application that is under development in the software development environment.

36. A computer-readable storage device storing software comprising instructions executable by one or more computers which, upon such execution, cause the one or more computers to perform operations comprising:
receiving an indication that a user has selected a control associated with obtaining virtual device profiles that are relevant to a software application that is under development in a software development environment;
in response to receiving the indication, automatically analyzing the software application that is under development in the software development environment to classify each feature of a set of hardware and software features as (i) a used feature that is used by the software application, or (ii) an unused feature that is not used by the software application and, for each feature that is classified as a used feature, to classify the used feature as (a) a mandatory used feature, or (b) an optional used feature;
selecting from among a set of virtual device profiles, a first subset of the virtual device profiles that each include, at a minimum, all of the hardware and software features that are classified as mandatory used features;
accessing data that identifies combinations of hardware and software features that are unlikely to occur together on a single device;
selecting, from among the first subset of the virtual device profiles, a second subset of the virtual device profiles that do not include one or more of the combinations of hardware and software features that are unlikely to occur together on a single device; and
outputting one or more of the virtual device profiles of the second subset as a virtual device profile that is relevant to the software application.

37. The storage device of claim 36, comprising:
invoking, by the software development environment, one or more of the virtual devices using the corresponding one or more virtual device profiles; and
installing, by the software development environment, the application on the one or more of the virtual devices.

38. The storage device of claim 36, wherein selecting the first subset of the virtual device profiles comprises selecting, from among the set of virtual device profiles, one or more excluded virtual device profiles that each do not include, at a minimum, all of the hardware and software features that are classified as mandatory used features, and excluding the excluded virtual device profiles from the first subset.

39. The storage device of claim 36, wherein one or more of the virtual device profiles of the first subset, but fewer than all of the virtual device profiles of the first subset, include hardware and software features that are classified as optional used features.
